(19) United States
(12) Patent Application Publication
(10) Pub. No.: US 2020/0046457 A1
(43) Pub. Date: Feb. 13, 2020

(54) Interim Provisional Restoration Placement Instrument-#1

(71) Applicant: Evelyn Anne-Bauschka Ayers, San Diego, CA (US)

(72) Inventor: Evelyn Anne-Bauschka Ayers, San Diego, CA (US)

(21) Appl. No.: 16/041,762

(22) Filed: Aug. 13, 2018

(51) Int. Cl. A61C 5/00; A61C 3/00; A61C 1/10

(52) U.S. Cl. CPC A61C 5/00; A61C 1/10; A61C 3/00

(57) ABSTRACT

This invention is a classic dental cow horn explorer that has been fitted with dycal style balls on the ends, for a completely new instrument designed to facilitate exacting placement of cavity liners and bases, spreading flowable composite underneath fillings by the Dentist, and placing Interim Therapeutic Restorations (ITR) such as fluoride releasing glass ionomer by the Dentist or Registered Dental Hygienist Expanded Functions (RDHEF).

Doctors then can reach over matrix bands and apply dental bases and liners, or spread flowable composite directly to the axial wall and pulp floor of their preps, and RDHEF's can access hard to reach interproximal, root and furcation areas to apply glass ionomer or other Interim Therapeutic Restorations where incipient caries have been hand excavated.

### TECHNICAL FIELD

The present invention generally relates to improvements in a dycal style instrument, and to the dental explorer: in particular to a merging of the dental explorer with the dycal instrument as we know them today into a totally new instrument: A STAINLESS STEEL DENTAL EXPLORER WITH SMALL BALLS ON THE ENDS instead of the current pointy ends.

### BACKGROUND ART

There are known explorers that can transfer dental cavity bases, liners, flowable composite, and Interim Therapeutic Restorations, but they are currently only pointed and inefficient at carrying materials on the end. There are known dycal instruments that also can do the same thing, but currently are too short at half handle sized and the angle of the end is one dimensional and limited in curvature and angulation, making it hard to access difficult to reach posterior prepped teeth, especially upper third molars, root surfaces, furcation areas, and distal areas.

### SUMMARY OF THE INVENTION

An object of the present invention is to provide a dental instrument that carries the correct curvature in 3D angulation, allowing the Dentist or Hygienist the turn the tip in any direction and be able to reach hard to access areas.

In accordance with the present invention, the balls on the end now can carry a larger amount of dental materials from the mixing pad to the patient's mouth.

Further, according to the present invention, the dentist or hygienist only needs to use one instrument instead of two separate ones, thus saving time and making the appointment time more cost effective for the producer.

### BRIEF DESCRIPTION OF THE DRAWINGS

FIG. 1 is a side view illustrating the preferred embodiment of the dental instrument according to the present invention. The ends of the instrument sprout 30 mm on either side of a 100 mm handle, resulting in a total length of 160 mm. The handle is 6 mm in diameter. The ball on the tip of the ends measures 7.5 mm.

FIG. 2 is a frontal view illustrating the curvature of the tips and the opposite angulation on either side. It is a cow horn style curved tip which begins with a 30 degree bend horizontally, then up to a 45 degree angle as it curves, ending 80 degrees to the handle short of vertical. The straight line distance from the beginning of the hook to the ball is 12 mm. The instrument is made of surgical grade medical stainless steel.

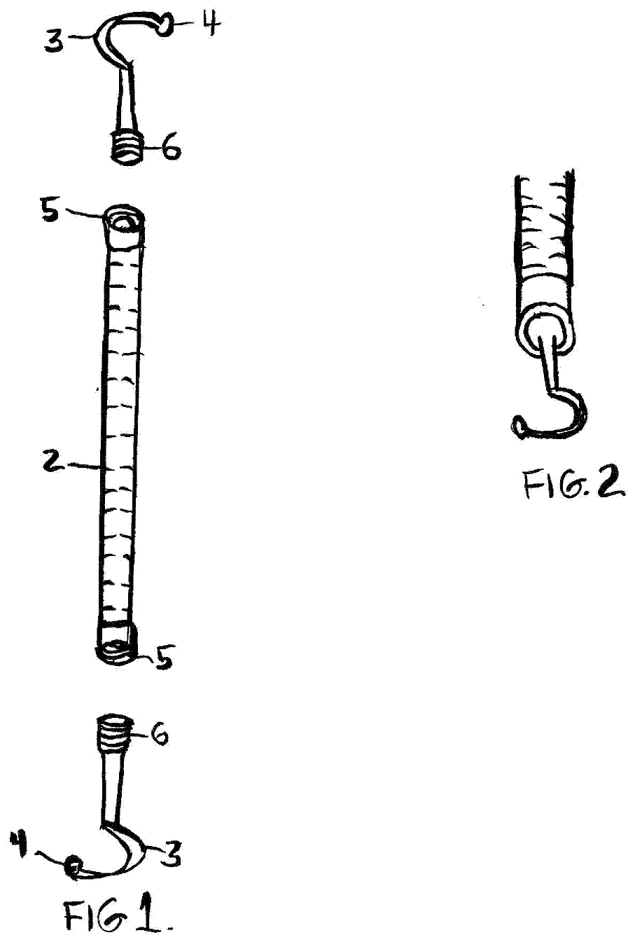

### DETAILED DESCRIPTION OF PREFERRED EMBODIMENTS

The Interim Therapeutic Restoration Placement instrument facilitates the placement of flowable composite, dental cavity bases and liners and Interim Therapeutic Restorations of glass ionomer or other such fluoride releasing temporary materials onto prepped and hand excavated teeth. The angulated design of the instrument helps to access difficult to reach posterior areas, incipient decay areas interproximally up or down deep reaching root surfaces, and into furcation areas The length of the instrument is especially welcome for patients with special health needs in cases where conventional restorative care is not available or needs to be deferred.

1. A dental hand instrument comprising:
a handle (2)
two tips (3) fixedly mounted on said handle at each end thereof: and
7.3 mm balls (4) fixedly mounted to the tips of the ends

2. The instrument as claimed in claim 1 characterized in that a handle (2) having threads (5) on an inner surface thereof for threadedly engaging said threads (6) on the outer surface of said two tips (3) with the 7.3 mm balls fixed on the tip ends.
